(19) United States
(12) Patent Application Publication
(10) Pub. No.: US 2025/0298247 A1
(43) Pub. Date: Sep. 25, 2025

(54) LATERAL OFFSET REFLECTOR FOR REFLECTIVE WAVEGUIDES

(71) Applicant: GOOGLE LLC, Mountain View, CA (US)

(72) Inventors: Daniel Adema, Kitchener (CA); Shreyas Potnis, Kitchener (CA)

(21) Appl. No.: 18/862,860

(22) PCT Filed: May 4, 2023
(86) PCT No.: PCT/US2023/020921

§ 371 Date: Nov. 4, 2024

Related U.S. Application Data
(60) Provisional application No. 63/340,139, filed on May 10, 2022.

(51) Int. Cl. G02B 27/01; G02B 27/00; G02B 27/14

(52) U.S. Cl. CPC G02B 27/0172; G02B 27/0081; G02B 27/14; G02B 2027/013; G02B 2027/0178

(57) ABSTRACT

Embodiments of techniques presented herein facilitate more optimal positioning of an incoupler and exit pupil expander within an eyeglass-type near-eye display system that includes an optical waveguide combiner. In certain embodiments, the optical waveguide combiner comprises an incoupler; an outcoupler; an exit pupil expander that comprises one or more reflective facets and is disposed in an optical path between the incoupler and the outcoupler; and an offset reflector facet disposed in the optical path between the incoupler and the exit pupil expander.

### BACKGROUND

The present disclosure relates generally to augmented reality (AR) eyewear, which fuses a view of the real world with a heads up display overlay. Wearable heads-up displays (WHUDs) are wearable electronic devices, such as near-eye display systems, that use optical combiners to combine real world and virtual images. The optical combiner may be integrated with one or more lenses to provide a combiner lens that may be fitted into a support frame of a WHUD. In operation, the combiner lens provides a virtual display that is viewable by a user when the WHUD is worn on the head of the user. One class of optical combiner uses a waveguide (also termed a lightguide) to transfer light. In general, light from a projector or other light engine of the WHUD enters the waveguide of the combiner through an incoupling optical structure (incoupler), propagates along the waveguide via total internal reflection (TIR), and exits the waveguide through an outcoupling optical structure (outcoupler). If the pupil of the eye is aligned with one or more exit pupils provided by the outcoupler, at least a portion of the light exiting through the outcoupler will enter the pupil of the eye, thereby enabling the user to see a virtual image. Because the combiner lens is transparent, the user will also be able to see the real world.

### BRIEF SUMMARY OF EMBODIMENTS

Embodiments are described herein to facilitate more optimal positioning of an incoupler and exit pupil expander within an eyeglass-type near-eye display system that includes an optical waveguide combiner.

In certain embodiments, an optical waveguide combiner comprises an incoupler; an outcoupler; an exit pupil expander that comprises one or more reflective facets and disposed in an optical path between the incoupler and the outcoupler; and an offset reflector facet disposed in the optical path between the incoupler and the exit pupil expander.

The offset reflector facet may be substantially parallel with at least one reflective facet of the one or more reflective facets of the exit pupil expander.

The offset reflector facet may be configured to compensate for a rotation of a display light caused by one or more interactions of the display light with one or more of the incoupler, exit pupil expander, and outcoupler.

The incoupler may be configured to direct display light from a light engine into the optical waveguide combiner along the optical path, such that the light engine is positioned proximate to a first side of the optical waveguide combiner. The outcoupler may be configured to direct the display light out of the optical waveguide combiner towards an eye of a user that is located proximate to the first side of the optical waveguide combiner, or may be configured to direct the display light out of the optical waveguide combiner towards an eye of a user that is located proximate to a second side of the optical waveguide combiner that is substantially opposite to the first side.

In certain embodiments, a near-eye display system comprises an eyeglasses frame; an ophthalmic lens that is coupled to the eyeglasses frame and comprises the optical waveguide combiner described above; and a light engine to project display light toward the incoupler. In certain embodiments, a method comprises operating the near-eye display system to project the display light from the light engine toward an eye of a user.

In certain embodiments, a method comprises directing display light into an optical waveguide combiner via an incoupler; and redirecting the display light by the incoupler along an optical path comprising one or more interactions with an outcoupler directing the display light out of the optical waveguide combiner towards an eye of a user, an exit pupil expander comprising one or more reflective facets and disposed in the optical path between the incoupler and the outcoupler, and an offset reflector facet disposed in the optical path between the incoupler and the exit pupil expander.

The offset reflector facet may be substantially parallel with at least one reflective facet of the one or more reflective facets of the exit pupil expander.

The method may further comprise substantially compensating via the offset reflector facet for a rotation of a display light introduced by the one or more interactions.

The method may further comprise directing the display light from a light engine into the optical waveguide combiner along the optical path, the light engine being proximate to a first side of the optical waveguide combiner. Directing the display light out of the optical waveguide combiner may include directing the display light towards an eye of a user that is located proximate to the first side of the optical waveguide combiner, or may include directing the display light towards an eye of a user that is located proximate to a second side of the optical waveguide combiner, the second side being substantially opposite to the first side.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 illustrates a diagram of a wearable near-eye display device in accordance with some embodiments.

FIG. 2 illustrates a typical positional relationship (alignment) in a waveguide combiner between an incoupler, an exit pupil expander, and an outcoupler.

FIGS. 3 and 4 illustrate a partial component view of a waveguide combiner in an ophthalmic lens coupled within an eyeglass frame.

FIG. 5 illustrates a partial 3D component view of a single display light ray encountering waveguide components in an ophthalmic lens implementation.

FIG. 6 illustrates a multi-ray partial 3D component view of a display light encountering waveguide components in an ophthalmic lens implementation.

FIG. 7 illustrates a multi-ray partial 3D component view of a display light encountering waveguide components in an ophthalmic lens implementation in accordance with some embodiments.

FIG. 8 illustrates a partial component view of a waveguide combiner in an ophthalmic lens implementation, in accordance with some embodiments.

FIGS. 9 and 10 illustrate top-down partial component views of respective waveguide combiners in accordance with some embodiments.

FIG. 11 is an operational flow diagram illustrating operations for facilitating more optimal positioning of an incoupler and EPE within an eyeglass-type near-eye display system, in accordance with some embodiments.

### DETAILED DESCRIPTION

A waveguide-based optical combiner (referred to herein as a waveguide combiner or simply a waveguide) is often used in augmented reality (AR)-based near-eye displays to provide a view of the real world overlayed with static imagery or video (recorded or rendered). Typically, such waveguides employ an incoupler (IC) to receive display light, an exit pupil expander (EPE) to increase the size of the display exit pupil, and an outcoupler (OC) to direct the resulting display light toward a user's eye.

Conventional waveguide combiners typically utilize a particular IC-EPE alignment that can impact the positioning of the IC and EPE in a near-eye display with an eyeglass form factor. For example, because the position of the incoupler is aligned with the position of the exit pupil expander, each serves to limit the position of the other. In certain scenarios, for example, implementation of such an aligned IC and EPE in a waveguide with an eyeglass form factor can limit the available shapes that an ophthalmic lens of the eyeglasses can employ. Previous solutions to this problem are typically associated with unfavorable positioning of the IC outside of the temple region of the display device, or unfavorable limitations on the shape and size of the ophthalmic lens implementing the waveguide combiner.

Embodiments of techniques presented herein facilitate more optimal positioning of the IC and EPE within an eyeglass-type near-eye display system, such as by utilizing an offset reflector—a reflective structure comprising one or more reflective facets that is positionally offset to allow realignment (positional decoupling) of the IC and the EP. Such techniques allow the IC to be positioned, for example, in a temple area of the incorporating eyeglasses (e.g., within or proximate to a temple arm and front frame of the eyeglasses) while allowing the EPE to be positioned in a manner compatible with many common shapes and sizes of ophthalmic lenses.

Discussions herein refer to planar (flat) or non-planar (curved) reflective optical waveguide combiners comprising various optical structures, such as periodic or other reflective structures formed in one or more optical substrates of the waveguide combiner. Periodic reflective structures described herein typically have periods on the order of 1 mm; for visible light wavelengths (e.g., wavelengths of approximately 350 to 700 nm), diffraction from such reflective structures will be minimal (e.g., on the order of 2 arcminutes), which are reasonably close to the Nyquist resolution of cones in the human retina. The absence of such diffraction is desirable for facets of various reflective optical structures, described herein, that are formed (as a non-limiting example) between two refractive index-matched complementary portions of optical substrate, with one or more reflective coatings applied on the interface between those portions. Although the resulting reflective facets are intended to be invisible to a user, the reflective coatings may cause diffraction effects in smaller-scaled optical structures. Moreover, in certain embodiments the facets of the described reflective structures are configured such that the spacing (pitch) of such facets avoids causing diffraction artifacts, while providing reflection sufficient to, for example, expand an eyebox provided by the incorporating waveguide combiner.

For ease of illustration, reflective optical components discussed herein (e.g., various incouplers, offset reflectors, EPEs, and outcouplers) depict a single reflective facet to represent each of those various optical components, with the understanding that each such optical component may comprise any quantity of such reflective facets to effectuate the purpose of that optical component.

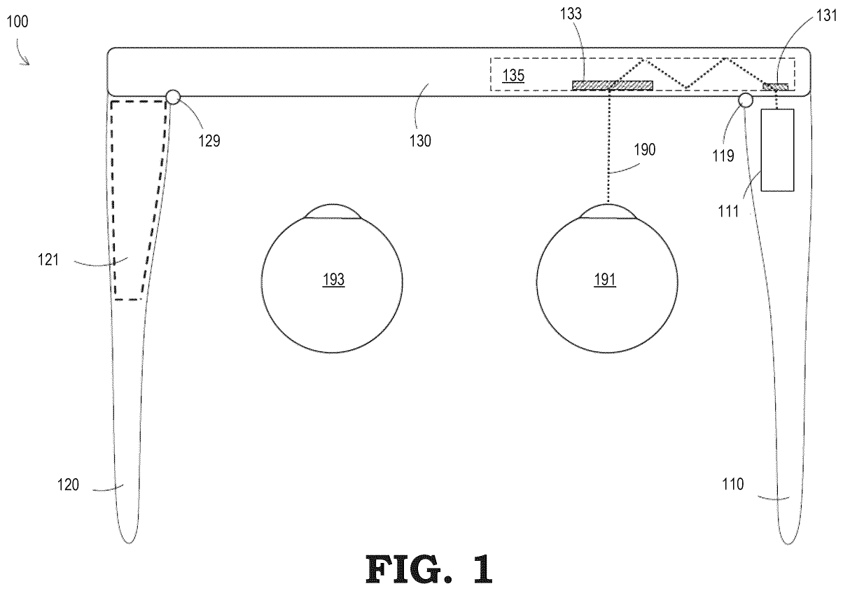

FIG. 1 illustrates a diagram of a wearable near-eye display device 100 in accordance with some embodiments. In the depicted embodiment, the display device 100 includes a first arm 110, a second arm 120, and a front frame 130. The first arm 110 is coupled to the front frame 130 by a hinge 119, which allows the first arm 110 to rotate relative to the front frame 130. The second arm 120 is coupled to the front frame 130 by the hinge 129, which allows the second arm 120 to rotate relative to the front frame 130.

In the depicted embodiment, the display device 100 is in an unfolded configuration, in which the first arm 110 and the second arm 120 are rotated such that the display device 100 can be worn on a head of a user, with the first arm 110 positioned on a first side of the head of the user, the second arm 120 positioned on a second side of the head of the user opposite the first side, and the front frame 130 positioned on a front of the head of the user. The first arm 110 and the second arm 120 can be rotated towards the front frame 130, until both the first arm 110 and the second arm 120 are approximately parallel to the front frame 130, such that the display device 100 may be in a compact shape that fits conveniently in a rectangular, cylindrical, or oblong case. In other embodiments, the first arm 110 and the second arm 120 may be fixedly mounted to the front frame 130, such that the display device 100 cannot be folded.

In the embodiment of FIG. 1, the first arm 110 carries a light engine 111. The second arm 120 carries a power source 121. The front frame 130 carries a waveguide 135 including an incoupling optical redirector (incoupler) 131, an outcoupling optical redirector (outcoupler) 133, and at least one set of electrically conductive current paths, which provide electrical coupling between the power source 121 and electrical components (such as the light engine 111) carried by the first arm 110. Such electrical coupling could be provided indirectly, such as through a power supply circuit, or could be provided directly from the power source 121 to each electrical component in the first arm 110.

In various embodiments, the light engine 111 may comprise a singular light source, a plurality of light sources, or a light engine assembly. A light engine assembly may include some components which enable the light engine 111 to function, or which improve operation of the light engine. As one example, a light engine may include a light source, such as a laser or a plurality of lasers. The light engine assembly may additionally include electrical components, such as driver circuitry to power the at least one light source. The light engine assembly may additionally include optical components, such as collimation lenses, a beam combiner, or beam shaping optics. The light engine assembly may additionally include beam redirection optics, such as least one MEMS mirror, which can be operated to scan light from at least one laser light source, such as in a scanning laser projector. In the above example, the light engine assembly includes a light source and also components, which take the output from at least one light source and produce conditioned display light to convey AR content. In various embodiments, some or all components in the light engine assembly are included in a housing of the light engine assembly, affixed to a substrate of the light engine assembly, such as a printed circuit board or similar, or separately mounted components of a wearable heads-up display (WHUD).

As used herein, the terms carry, carries or similar do not necessarily dictate that one component physically supports another component. For example, it is stated above that the first arm 110 carries the light engine 111. This could mean that the light engine 111 is mounted to or within the first arm 110, such that the first arm 110 physically supports the light engine 111. However, it could also describe a direct or indirect coupling relationship, even when the first arm 110 is not necessarily physically supporting the light engine 111.

In operation, light engine 111 outputs a display light 190 (simplified for this example) representative of AR content or other display content to be viewed by a user. The display light 190 is redirected by waveguide 135 towards an eye 191 of the user, such that the user can see the AR content. The display light 190 from the light engine 111 impinges on the incoupler 131 and is redirected to travel in a volume of the waveguide 135, where the display light 190 is guided through the light guide, such as by total internal reflection (TIR) or surface treatments such as holograms or reflective coatings. Subsequently, the display light 190 traveling in the volume of the waveguide 135 impinges on the outcoupler 133, which redirects the display light 190 out of the light guide redirector and towards the eye 191 of a user.

In certain embodiments, the display device 100 includes a processor (not shown) that is communicatively coupled to each of the electrical components in the display device 100, including but not limited to the light engine 111. The processor can be any suitable component which can execute instructions or logic, including but not limited to a micro-controller, microprocessor, multi-core processor, integrated-circuit, ASIC, FPGA, programmable logic device, or any appropriate combination of these components. In various embodiments, the display device 100 includes a non-transitory processor-readable storage medium, which may store processor-readable instructions thereon. Such instructions, when executed by the processor, can cause the processor to execute any number of functions, including (as non-limiting examples): causing the light engine 111 to output the display light 190 representative of display content to be viewed by a user; receiving user input; managing user interfaces; generating display content to be presented to a user; receiving and managing data from any sensors carried by the display device 100; receiving and processing external data and messages; and any other functions as appropriate for a given application. The non-transitory processor-readable storage medium can be any suitable component that can store instructions, logic, or programs, including but not limited to non-volatile or volatile memory, read-only memory (ROM), random-access memory (RAM), FLASH memory, registers, magnetic hard disk, optical disc, or any combination of these components.

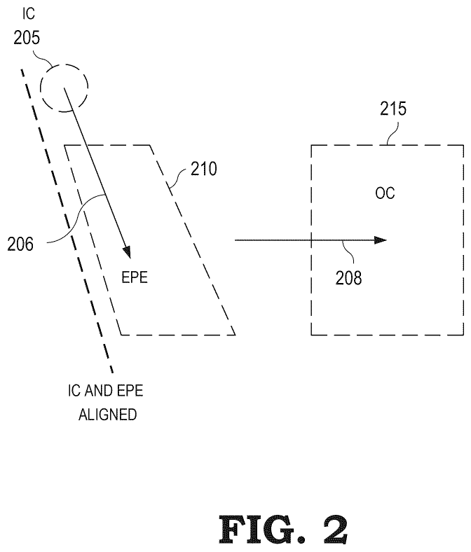

FIG. 2 illustrates a typical positional relationship (alignment) between waveguide components—in particular, between an incoupler 205, an exit pupil expander 210, and an outcoupler 215. Display light enters the incorporating waveguide at incoupler 205 (such as after being generated by a light engine, not shown) and is directed along a first propagation path 206 towards EPE 210. For ease of illustration, the incoupler 205 and EPE 210 represent single facets of incoupler and EPE structures, respectively. Also for ease of illustration, the first propagation path 206 is depicted as a unidirectional ray, although it will be appreciated that, as described elsewhere herein, display light following the first propagation path 206 is typically directed towards the EPE 210 via a series of one or more redirections via total internal reflection (TIR), such as when encountering one or more external surfaces of the incorporating waveguide.

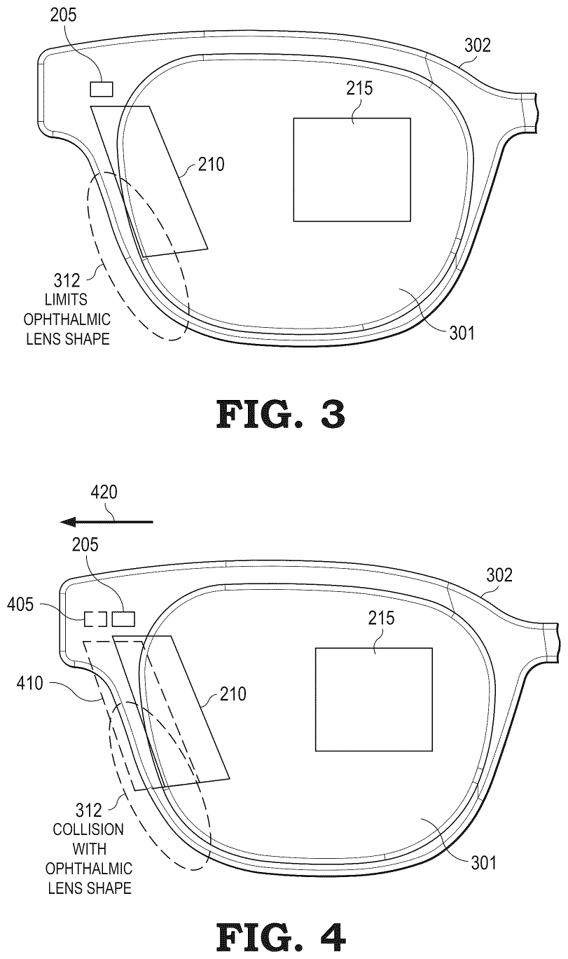

As display light following the first propagation path 206 encounters the EPE 210, it is reflected by the EPE 210 to follow a second propagation path 208 towards outcoupler 215. Notably, the dimensions and configuration of the EPE 210 are selected in a manner to align with the first propagation path 206 and with the second propagation path 208, indicating that those dimensions and that configuration depend on the orientation and placement of both the incoupler 205 and outcoupler 215. Effects of this type of dependency are further illustrated below with respect to FIG. 3.

FIG. 3 illustrates a partial component view of the waveguide components from FIG. 2 in an ophthalmic lens implementation, where an ophthalmic lens 301 is coupled within a partially depicted eyeglass frame 302 as viewed from the front. Incoupler 205 is positioned within the temple region of this eyeglass-type near-eye display. However, placement of the incoupler 205 is constrained by the corresponding position of EPE 210, and in particular by the leftmost edge of EPE 210 as it abuts the interface of the ophthalmic lens 301 with the eyeglass frame 302 in region 312. In this and other scenarios, the alignment between incoupler 205 and EPE 210 limits the potential size and/or curvature of the ophthalmic lens 301 and eyeglass frame 302.

Such limitation is further illustrated in FIG. 4, which again illustrates a partial component view of the waveguide components from FIG. 2, such that the ophthalmic lens 301 is coupled within eyeglass frame 302. In this and other scenarios, it may be advantageous to modify the position of incoupler 205, such as to move in direction 420 to a new IC position 405. However, such placement of the incoupler 205 is generally disallowed by the resulting corresponding position of EPE 410, which would then extend beyond the boundary defined by the interface of ophthalmic lens 301 and eyeglass frame 302 within the region 312. Ophthalmic lens 301 with the eyeglass frame 302 in region 312. Thus, the alignment between the incoupler and the EPE limits the size and/or curvature that can be employed for the region of the ophthalmic lens below the incoupler 205.

While it is possible in certain implementations to maintain the traditional alignment between the incoupler 205 and EPE 210 and position the EPE 210 entirely within the ophthalmic lens 301—such as by either moving the incoupler 205 out of the temple area and toward the user's head, or utilizing an oblique angled input of the display light into the IC 205—both solutions may adversely impact the resulting display position and/or other types of waveguide structures that may be present.

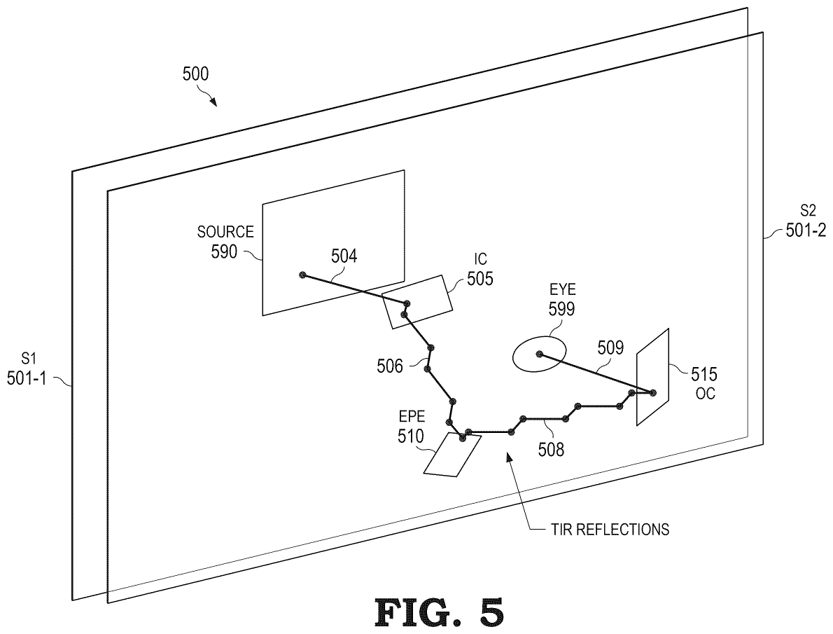

FIG. 5 illustrates a partial 3D component view of a single display light ray encountering waveguide components, such as in an ophthalmic lens implementation. In the depicted embodiment, a light engine 590 emits a display light 504 towards an incoupler 505. The incoupler 505 redirects the display light into a waveguide 500 along a first propagation path 506 (via a series of TIR reflections between a first waveguide boundary 501-1 and a second waveguide boundary 501-2) towards a facet of an EPE 510. The display light encounters the facet of EPE 510 and is consequently redirected along a second propagation path 508 (again via TIR reflections between waveguide boundaries 501-1 and 501-2) towards the outcoupler 515. The display light is redirected by outcoupler 515 towards a user's eye 599 to present AR content represented by the redirected display light 509.

Although the depiction of a single display light ray is illustrative for purposes of depicting the propagation path of display light within the incorporating waveguide, it does not adequately depict another complication associated with reflective facet-based waveguide configurations.

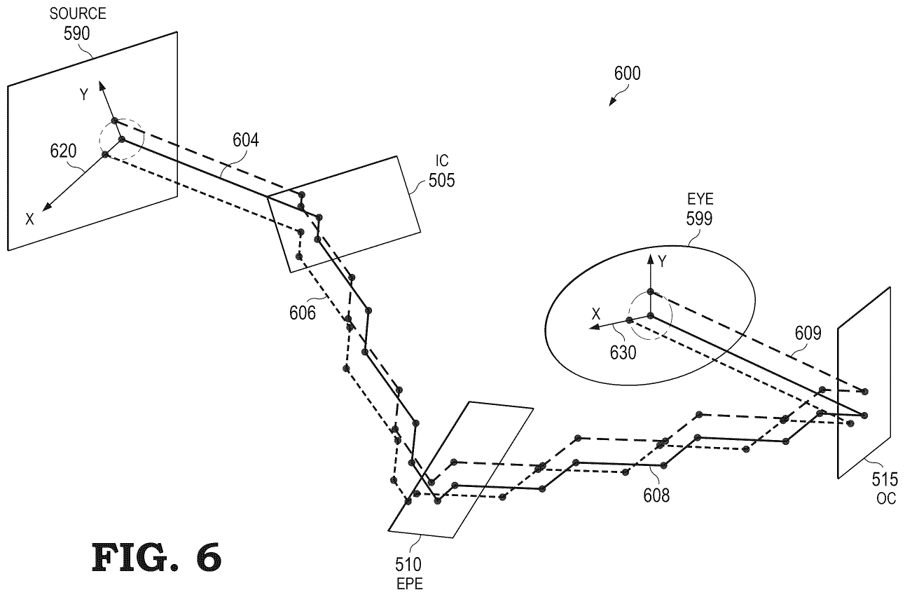

FIG. 6 illustrates a multi-ray partial 3D component view of a display light encountering components of a waveguide combiner 600 in an ophthalmic lens implementation. More generally, FIG. 6 illustrates the usage of reflective facets in such waveguide components, which in contrast to other types of such components (e.g., diffractive gratings) are subject to design implications resulting from image rotation due to the compound angles of the relevant reflective facets. As seen from rotational axis indicators 620 and 630, in order to achieve the desired rotational outcome being displayed to the user's eye 599, the orientation of light engine 590 must compensate for the respective rotations of the display light rays resulting from successive reflections along the propagation paths 606, 608, and 609. For example, the light engine 590 may need to be mounted at an irregular angle with respect to the IC 505.

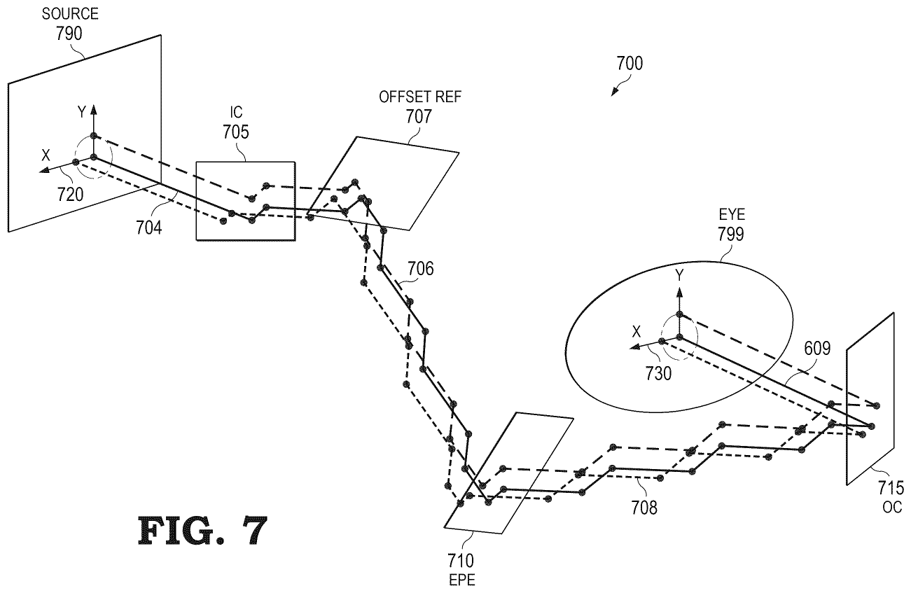

FIG. 7 illustrates a partial 3D component view of a multi-ray display light encountering waveguide components in an ophthalmic lens implementation, in accordance with some embodiments. In particular, the multi-ray partial 3D component view illustrates a facet-based waveguide combiner 700 that introduces an offset reflector 707 between an IC 705 and an EPE 710.

In a manner similar to that described above with respect to waveguide combiners 500 and 600, in the waveguide combiner 700 a light engine 790 emits a display light 704 towards incoupler 705. However, rather than redirect the display light directly into the waveguide 700 and towards the EPE 710 (as described above with respect to incoupler 505 of FIG. 5), the incoupler 705 redirects the display light 704 towards an additional offset reflector 707, which then redirects the display light along propagation path 706 (and via TIR reflection) towards EPE 710. The display light encounters EPE 710 and is consequently redirected along propagation path 708 (again via TIR reflection) towards the outcoupler 715, which redirects the display light towards user's eye 799.

The offset reflector 707 effectively decouples the positions of IC 705 and EPE 710, facilitating more optimal positioning of both. For example, in various embodiments the incoupler 705 is positioned in the temple area while still enabling the EPE 710 to be positioned in a manner compatible with many common shapes and sizes of ophthalmic lenses.

Moreover, as seen from rotational axis indicators 720 and 730, in the depicted embodiment the offset reflector 707 is configured to effectively compensate (in contrast to the scenario described above with respect to waveguide combiner 500 in FIG. 5) for the respective rotations of the display light rays resulting from successive reflections along their propagation path between IC 705, offset reflector 707, EPE 710, and outcoupler 715. In addition, in certain embodiments the offset reflector 707 is configured to be substantially parallel with EPE 710, such as to avoid further image rotation that would require further compensation elsewhere in the optical path.

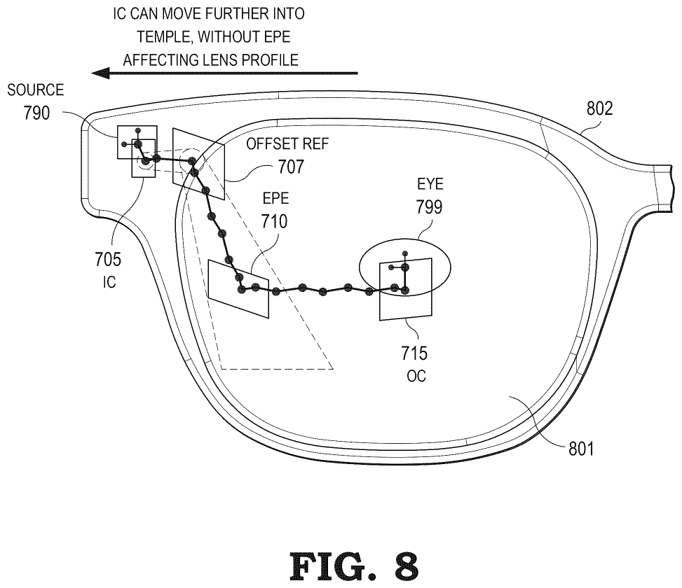

FIG. 8 illustrates a partial component view of waveguide combiner 700 in an ophthalmic lens implementation, in accordance with some embodiments. In the depicted embodiment, an ophthalmic lens 801 is coupled within a partial wireframe eyeglass frame 802 (as viewed from the front). Notably, because the IC 705 and EP 710 are positionally decoupled by virtue of the intervening offset reflector 707, the IC 705 may be advantageously positioned—for example, further towards the temple area of the eyeglass frame 302, such as to facilitate beneficial placement of light engine 790—without affecting the position of the EPE 710 to extend beyond the interface boundary of ophthalmic lens 801 and eyeglass frame 802.

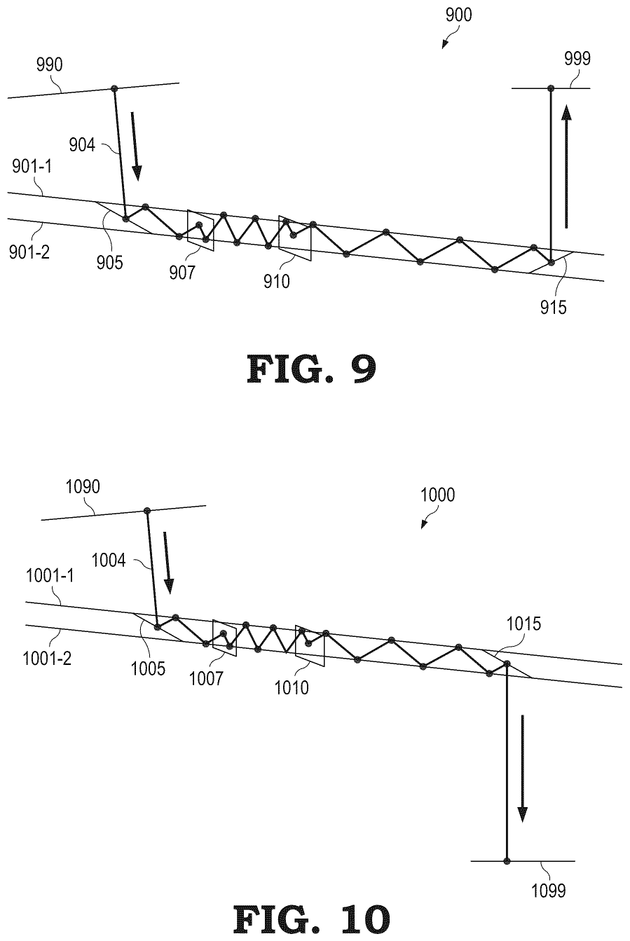

FIGS. 9 and 10 illustrate top-down partial component views of respective waveguide combiners in accordance with some embodiments. In particular, FIG. 9 illustrates optical components of a waveguide combiner 900 configured to outcouple a display light 904 towards an eye of a user from a light engine 990 that is positioned to be on the same side of the waveguide 900 as that user's eye. In contrast, FIG. 10 illustrates optical components of a waveguide combiner 1000 configured to outcouple a display light 904 towards an eye of a user from a light engine 990 that is positioned to be on an opposing side of the waveguide 900 as the eye of the user.

In a manner similar to that described above with respect to FIGS. 7 and 8, in the waveguide combiner 900 a light engine 990 emits a display light 904 towards incoupler 905, which redirects the display light 904 into the waveguide 900 and towards offset reflector 907, via TIR interactions with waveguide boundaries 901-1 and 901-2. As a result of its interaction with offset reflector 907, the display light 904 is redirected (via TIR reflection) towards EPE 910. The display light 904 encounters EPE 910 and is consequently redirected (again via TIR reflection) towards the outcoupler 915, which redirects the display light towards user's eye 999.

FIG. 10 generally depicts a waveguide combiner 1000 that in operation acts in a manner similar to that described above with respect to waveguide combiner 900, but is configured such that the user's eye 1099 is positioned on a side of the waveguide combiner 1000 opposite that of the light engine 1090. In particular, light engine 1090 emits a display light 1004 towards incoupler 1005, which redirects the display light 1004 into the waveguide 1000 and towards offset reflector 1007 via TIR interactions with waveguide boundaries 1001-1 and 1001-2. As a result of its interaction with offset reflector 1007, the display light 1004 is redirected (via TIR reflection) towards EPE 1010. The display light 1004 encounters EPE 1010 and is consequently redirected (again via TIR reflection) towards the outcoupler 1015, which redirects the display light towards a user's eye 1099.

It will be appreciated that although for purposes of clarity FIGS. 2-10 depict a single reflective facet to represent each of various optical components (e.g., the respective incouplers, offset reflectors, EPEs, and outcouplers of waveguide combiners 500, 600, 700, 800, 900, 1000), in embodiments each of these reflective structures includes more than one such reflective facet. It will also be appreciated that while such optical components are described as reflective in the discussions herein, in various embodiments one or more of such optical components may comprise various diffractive architectures as well, such as to utilize a diffractive grating for one or more of incouplers 705, 805, 905, 1005, or of outcouplers 715, 815, 915, and 1015.

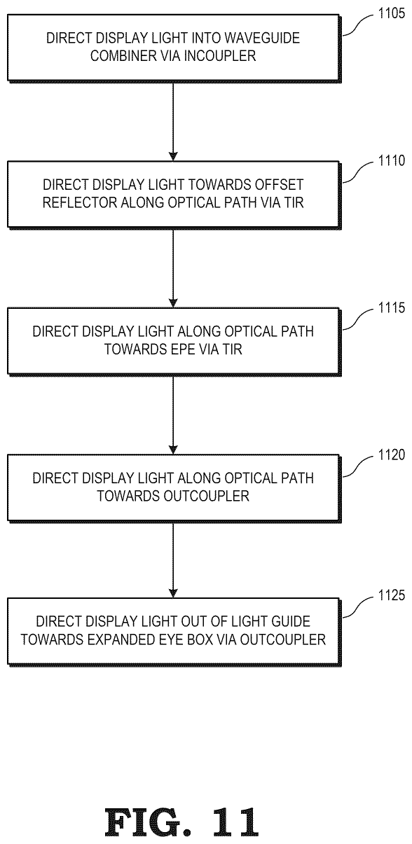

FIG. 11 is an operational flow diagram illustrating operations for facilitating more optimal positioning of an incoupler and EPE within an eyeglass-type near-eye display system, in accordance with some embodiments. The illustrated operations begin at block 1105.

At block 1105, a display light (e.g., display light 704, 904, 1004 of FIGS. 7, 9, 10, respectively) is directed into a waveguide combiner (e.g., one of waveguide combiners 700, 900, 1000 of FIGS. 7, 9, 10, respectively) via an incoupler (e.g., one of incouplers 705, 905, 1005 of FIGS. 7, 9, 10, respectively).

At block 1110, the display light is directed towards an offset reflector (such as one of offset reflectors 707, 907, 1007 of FIGS. 7, 9, 10, respectively) via TIR. The routine proceeds to block 1115.

At block 1115, the display light is redirected along its optical path towards an exit pupil expander (e.g., EPE 710, 910, 1010 of FIGS. 7, 9, 10, respectively). The routine proceeds to block 1120.

At block 1120, the display light is redirected along its optical path from the EPE towards an outcoupler (e.g., outcoupler 715, 915, 1015 of FIGS. 7, 9, 10, respectively). The routine proceeds to block 1125.

At block 1125, the display light is redirected out of the light guide towards an eye of a user via the outcoupler. As noted elsewhere herein, the eye of the user may be located proximate to a side of the waveguide combiner that is proximate to, or opposite to, the light engine that directs the display light into the waveguide combiner at block 1105.

In some embodiments, certain aspects of the techniques described above may be implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disk, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

1. An optical waveguide combiner comprising:
an incoupler;
an outcoupler;
an exit pupil expander comprising one or more reflective facets and disposed in an optical path between the incoupler and the outcoupler; and
an offset reflector facet disposed in the optical path between the incoupler and the exit pupil expander.

2. The optical waveguide combiner of claim 1, wherein the offset reflector facet is substantially parallel with at least one reflective facet of the one or more reflective facets of the exit pupil expander.

3. The optical waveguide combiner of claim 1, wherein the offset reflector facet is configured to compensate for a rotation of a display light caused by one or more interactions of the display light with one or more of the incoupler, exit pupil expander, and outcoupler.

4. The optical waveguide combiner of claim 1, wherein the incoupler is configured to direct display light from a light engine into the optical waveguide combiner along the optical path, and wherein the light engine is positioned proximate to a first side of the optical waveguide combiner.

5. The optical waveguide combiner of claim 4, wherein the outcoupler is configured to direct the display light out of the optical waveguide combiner towards an eye of a user that is located proximate to the first side of the optical waveguide combiner.

6. The optical waveguide combiner of claim 4, wherein the outcoupler is configured to direct the display light out of the optical waveguide combiner towards an eye of a user that is located proximate to a second side of the optical waveguide combiner that is substantially opposite to the first side.

7. A near-eye display system comprising:
an eyeglasses frame;
an ophthalmic lens that is coupled to the eyeglasses frame and comprises an optical waveguide combiner comprising:
an incoupler;
an outcoupler;
an exit pupil expander comprising one or more reflective facets and disposed in an optical path between the incoupler and the outcoupler; and
an offset reflector facet disposed in the optical path between the incoupler and the exit pupil expander; and
a light engine to project display light toward the incoupler.

8. The near-eye display system of claim 7, wherein the offset reflector facet is configured to compensate for a rotation of the display light caused by one or more interactions of the display light with one or more of the incoupler, exit pupil expander, and outcoupler

9. A method, comprising:
directing display light into an optical waveguide combiner via an incoupler; and
redirecting the display light by the incoupler along an optical path comprising one or more interactions with:
an outcoupler directing the display light out of the optical waveguide combiner towards an eye of a user;
an exit pupil expander comprising one or more reflective facets and disposed in the optical path between the incoupler and the outcoupler; and
an offset reflector facet disposed in the optical path between the incoupler and the exit pupil expander.

10. The method of claim 9, wherein the offset reflector facet is substantially parallel with at least one reflective facet of the one or more reflective facets of the exit pupil expander.

11. The method of claim 9, further comprising substantially compensating via the offset reflector facet for a rotation of a display light introduced by the one or more interactions.

12. The method of claim 9, further comprising directing the display light from a light engine into the optical waveguide combiner along the optical path, the light engine being proximate to a first side of the optical waveguide combiner.

13. The method of claim 12, wherein directing the display light out of the optical waveguide combiner includes directing the display light towards an eye of a user that is located proximate to the first side of the optical waveguide combiner.

14. The method of claim 12, wherein directing the display light out of the optical waveguide combiner includes directing the display light towards an eye of a user that is located proximate to a second side of the optical waveguide combiner, the second side being substantially opposite to the first side.
